(19) United States
(12) Patent Application Publication
(10) Pub. No.: US 2026/0352460 A1
(43) Pub. Date: Nov. 5, 2026

(54) Secure Cryptographic Signature Transmission Without Server Retention

(71) Applicants: Henry T. Verheyen, Marina, CA (US); Robert Biczek, Los Altos, CA (US)

(72) Inventors: Henry T. Verheyen, Marina, CA (US); Robert Biczek, Los Altos, CA (US)

(73) Assignee: Thunderport, Marina, CA (US)

(21) Appl. No.: 19/666,256

(22) Filed: May 3, 2026

Related U.S. Application Data
(60) Provisional application No. 63/799,163, filed on May 2, 2025.

(51) Int. Cl. H04L 9/08; H04W 12/30

(52) U.S. Cl. CPC H04L 9/0894; H04L 9/083; H04W 12/30

(57) ABSTRACT

A system and method for stateless, QSS-based verification of externally signed instructions on a mobile device. The invention enables trust validation using vault-anchored public keys without requiring identity credentials, session tokens, or persistent backend state. Payloads signed by third-party servers, including financial institutions, are verified within the device's secure vault. Trust is established via a one-time post-quantum key exchange with a Companion App Admin Server, after which subsequent validation workflows operate using vault-resident verification material and symmetric cryptographic protections, with optional obfuscation layers. The architecture supports zero-PII operation and protected local workflow execution without backend acknowledgment, and limits exposure to classical asymmetric vulnerabilities by confining asymmetric operations to initial trust establishment.

### CROSS-REFERENCE TO RELATED APPLICATIONS

This application claims priority under 35 U.S.C. § 119(e) to U.S. Provisional Application No. 63/799,163, filed May 2, 2025, the contents of which are incorporated herein by reference in their entirety.

### FIELD OF THE INVENTION

This invention relates to stateless mobile security systems that enable secure instruction validation from external parties without persistent identity, credential exchanges, or backend session state. Specifically, the invention facilitates QSS-compliant, vault-bound verification of externally signed messages, such as those issued by banking systems, payment processors, or regulatory authorities.

The disclosed system activates cryptographic functions only after dual-party opt-in—by both the end-user and a pre-authorized protected service. No private keys are embedded, exported, or distributed in the client-side software, and verification operations are performed using vault-resident key material within a protected execution environment.

### BACKGROUND OF THE INVENTION

Existing mobile systems for third-party instruction processing rely on fragile authentication primitives, including user credentials, session cookies, OAuth tokens, or centralized device registries. These mechanisms introduce significant attack surfaces:
Signature spoofing or credential theft
Static key compromise
Backend replay or instruction hijacking

Further, as these models are often based on traditional cryptography (e.g., RSA, ECC), they remain vulnerable to quantum computing threats, particularly where signed payloads are retained or can be replayed.

There is a critical need for a lightweight, cryptographically enforced instruction verification method that:
Does not store persistent backend session state
Validates third-party instructions using post-quantum secure mechanisms
Operates independently of user credentials, identity assertions, or internet-facing identity providers
Is compatible with vault-sealed device architectures, enabling internal-only signature validation

### SUMMARY OF THE INVENTION

This invention implements a two-phase trust model, establishing QSS-based asymmetric trust during initial pairing and thereafter performing instruction validation workflows using vault-resident verification material and symmetric cryptographic protections, with optional obfuscation layers.

The invention describes a QSS-based architecture that allows a mobile device to verify externally signed instructions in a vault-sealed and stateless manner, without reliance on persistent sessions, traditional asymmetric credentials, or centralized user identity models.

A cryptographically signed payload is received from a trusted third-party system (e.g., a bank server). This payload is verified within the mobile device using a vault-anchored public key validation engine. Upon successful validation, the payload may trigger protected workflows such as fund release, permission elevation, or device-based decisioning.

All verification occurs locally and does not require round-trip confirmation or online credentialing. The private cryptographic context never leaves the device vault.

Vaults are initialized during secure installation and bound to a QSS-based trust root using a post-quantum key exchange during first pairing. Thereafter, signed instruction payloads are verified using vault-resident verification keys and policy logic, and integrity protection of instruction transport may be provided using symmetric keys derived from vault-sealed trust anchors, with optional obfuscation layers to reduce predictability of externally observable traffic.

In a preferred embodiment, the device maintains directional session keys—specifically, a persistent Receive Key used for inbound instruction encryption by third-party servers and a private Send Key used for outbound communication. This enforces cryptographic unidirectionality and prevents trust reversal or signature spoofing through bidirectional key misuse.

Quantum Classification Context:
As used herein, cryptographic protections are classified as:
   Quantum-Exposed: Classical asymmetric systems vulnerable to quantum attack (e.g., RSA, ECC).
   Quantum-Resilient: Partial resistance, e.g., hybrid schemes.
   Quantum-Hardened: Enhanced classical or hybrid systems with structural defenses (e.g., recursive obfuscation).
   Quantum-Safe: Systems architected to eliminate classical vulnerabilities entirely, relying exclusively on post-quantum cryptographic primitives and adaptive, dynamically hardened structures, thereby preventing both real-time and retroactive decryption even under quantum-capable adversaries.
   Quantum-Secure Substrate (QSS): The QSS represents the foundational cryptographic and architectural layer upon which a Post-Quantum Secure Network (PSN) is constructed. While not a PSN in itself, the QSS eliminates classical vulnerabilities and metadata exposure through stateless key handling, dynamic session rotation, and protocol-level obfuscation. It provides a trustless, identity-free communications substrate that resists both quantum and classical attack vectors, forming the secure groundwork for multi-hop, directionally encrypted network architectures.

The invention ensures forward secrecy by dynamically rotating symmetric keys and zeroizing prior session material, preventing retroactive compromise even in the event of future key disclosure.

The present invention qualifies as QSS-compliant by using post-quantum asymmetric key exchange for initial trust establishment and performing subsequent validation and workflow execution using vault-resident verification material and dynamically managed symmetric cryptography within a secure vault context.

Furthermore, mobile application security standards, including the OWASP Mobile Application Security Verification Standard (MASVS) and the OWASP Mobile Application Security Testing Guide (MASTG), have identified persistent weaknesses in areas such as device identity management, cryptographic key lifecycle, session trust establishment, and resistance to traffic interception or tampering. Existing solutions frequently rely on static credentials, predictable key exchange patterns, or centralized server mediation—all of which introduce exploitable attack surfaces. The present invention addresses these vulnerabilities through a fully decentralized, QSS-based cryptographic trust architecture, reducing classical exposure by confining asymmetric operations to initial trust establishment and supporting forward-secure, stateless operation.

This architecture is consent-based, cryptographically insulated, and jurisdictionally controlled. It is not an exported cryptographic tool, but a secure trust utility activated only through authorized provisioning and dual-party opt-in.

### DETAILED DESCRIPTION

1. Vault Initialization
During installation, the Companion App initializes a secure vault on the mobile device.
The vault provisions device-local cryptographic material used for trust establishment and storage of verification keys, and prevents export of private key material to application-level memory.

2. Trust Anchor Establishment
The device performs a post-quantum key exchange with a CA Admin Server.
A symmetric trust anchor is derived and stored locally.

3. External Payload Reception
A third-party server generates a signed payload and delivers it to the mobile device.
The payload includes message content and a freshness indicator selected from a nonce or timestamp, and a digital signature generated by the third-party authority.

4. Local Signature Verification
The Companion App performs internal-only validation using a third-party public verification key anchored within the vault.
In one embodiment, transport integrity and anti-tamper protection for delivery of the signed payload are provided using symmetric integrity validation derived from vault-sealed trust anchors.

5. Workflow Activation
If validated, the payload may initiate a pre-approved secure workflow (e.g., confirm transaction, elevate permissions).
No session state or backend acknowledgment is required.

6. Stateless Trust Flow
The CA Admin Server does not persist session data or instruction results.
All trust operations are performed locally with vault-contained data. 7. Directional Key Enforcement
In a preferred embodiment, the device maintains two separate symmetric keys:
   A Receive Key, distributed to trusted external systems for encrypted instruction delivery
   A Send Key, retained privately within the vault for outbound communication
These keys are isolated in vault compartments and rotated independently.
This directional structure blocks replay, traffic mirroring, and key reflection attacks.
The device does not transmit an acknowledgment or response indicating whether validation succeeded, and external observers cannot determine success from protocol metadata alone.

### ADVANTAGES OF THE INVENTION

The invention provides the following technical and operational advantages:
1. No Signature Retention at Admin Server: Eliminates attack surface and reduces regulatory compliance risks associated with server-side retention.
2. Authority-Controlled Signing: Trusted third parties generate and manage instruction signatures under their own authority policies.
3. Device-Bound Validation: Runtime validation is performed locally without server-side verification queries.
4. Vault-Sealed Operational Flexibility: Supports semi-permanent vault-sealed operation and optional complexity tradeoffs under policy control.
5. QSS-Compliant Cryptographic Posture: Confines asymmetric operations to initial trust establishment and uses vault-resident verification material with dynamic symmetric protections thereafter.
6. Compliance Alignment: The disclosed system mitigates or eliminates critical mobile security risks documented in OWASP MASVS and MASTG frameworks, including static secret exposure, insecure trust establishment, session key mismanagement, and device identity vulnerabilities.

The present invention may be implemented independently or in combination with related inventions disclosed in companion applications filed contemporaneously herewith by the same applicant.

[For Non-Provisional: This application claims the benefit of and builds upon the technical disclosures of U.S. Provisional Patent Application No. XXXXXX, titled ‘[Title]’, filed May 2025, and the earlier U.S. Patent Nos. 20220150220 and 12126603.]

No private key material is exported from the vault, and verification operations are performed using vault-resident key material within a protected execution environment after authorized pairing and activation.

### VI. LIST OF FIGURES

FIG. 1 is a diagram showing signature generation and sealing at the Bank Server, where a signature payload is constructed and encrypted using asymmetric or symmetric methods.

FIG. 2 illustrates the sealed payload relay process through the Companion App Admin Server to the mobile device, where it is decrypted and used for runtime validation.

FIG. 3 depicts the end-to-end flow of sealed signature delivery, vault integration, and runtime validation by the Companion App.

FIG. 4 shows a conceptual block diagram where a sealed cryptographic signature is transmitted via the Admin Server and bound to a mobile device's vault for stateless trust elevation.

### VII. BRIEF DESCRIPTION OF THE DRAWINGS

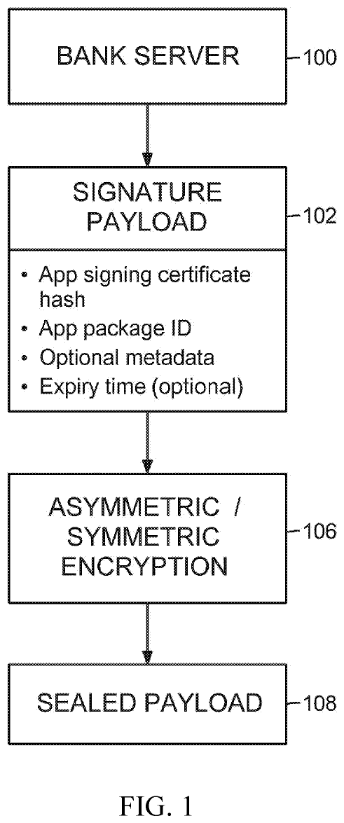

FIG. 1—Signature Generation and Sealing

This diagram illustrates the bank-side generation of a cryptographic signature payload. The payload includes an application certificate hash, package ID, and optional metadata (e.g., expiration). It is sealed using asymmetric encryption for initial trust exchange, or symmetric keys thereafter. The output is a sealed payload destined exclusively for the target mobile device.

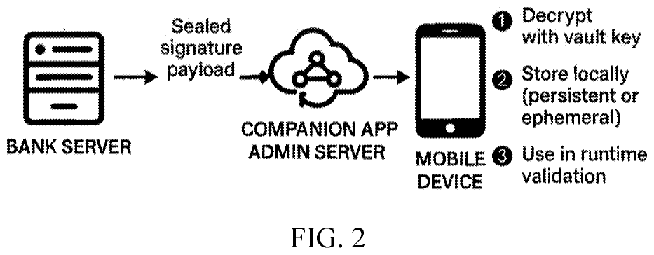

FIG. 2—Encrypted Payload Relay and Local Binding

A conceptual flow showing a sealed signature payload being transmitted from the bank server through the Companion App Admin Server to a mobile device. Upon receipt, the mobile device decrypts the payload using its vault key, stores it based on policy (semi-permanent, vault sealed or persistent), and uses it during local runtime validation.

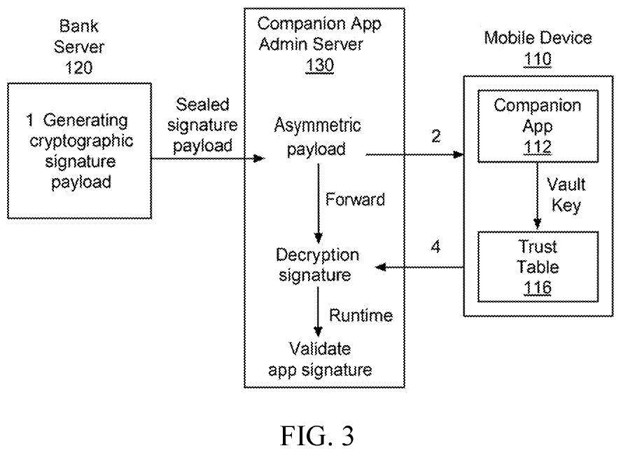

FIG. 3—End-to-End Signature Validation Workflow

A flowchart representing the full end-to-end process. The bank server generates the payload (Step 1), which is relayed (Step 2) by the Companion App Admin Server. The mobile device decrypts and stores the signature securely (Vault Key+Trust Table). Upon app launch or trigger, the Companion App validates the app against the stored signature (Step 4).

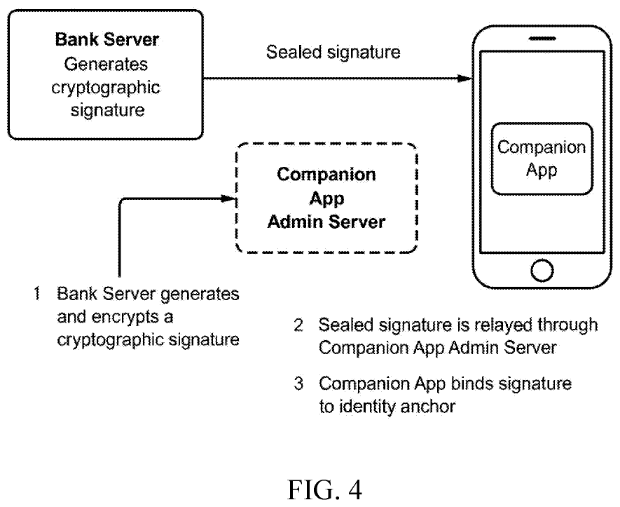

FIG. 4—Stateless Trust Binding via Sealed Signature

An annotated block diagram summarizing the system's operation: the bank generates a cryptographic signature, encrypts it, and sends it via the CA Admin Server. The mobile device's Companion App binds the decrypted payload to its internal identity anchor using vault-secured operations. No real-time trust resolution or server-side credentialing is required.

What is claimed is:

1. An apparatus for stateless validation of externally signed instructions on a mobile device
without reliance on identity credentials or persistent backend session state, the apparatus comprising:
a hardware-backed secure execution environment isolated from application-level memory;
a vault-sealed public key store configured to retain one or more third-party public verification keys in a non-exportable form;
an instruction reception module configured to receive an externally generated signed payload from a third-party system;
an internal validation engine configured to verify the signed payload entirely within the secure execution environment using vault-resident verification material;
a protected workflow controller configured to conditionally trigger a local device action only upon successful internal validation of the signed payload; and
a stateless enforcement module configured to perform validation and workflow execution without transmitting a validation acknowledgment, identity credential, or session state to any external system,
wherein the apparatus performs all signature verification locally without reliance on persistent user identity, account credentials, or backend validation services;
wherein validation of the signed payload is performed without reliance on a public key infrastructure, centralized verification service, or externally stored recovery credential; and
wherein successful validation is not externally observable to the third-party system or any intermediary service.

2. A method for stateless, post-quantum secure validation of externally signed instructions on a mobile device, the method comprising:
receiving a signed instruction payload from a third-party server;
verifying, within a hardware-backed secure vault, the authenticity of the signed payload using a vault-resident verification key;
determining whether the signed payload satisfies a predefined trust policy stored within the secure vault;
triggering a protected local workflow on the mobile device only upon successful internal validation; and
suppressing transmission of any externally observable validation success indicator, session identifier, or identity credential.

3. An apparatus for secure execution of externally authorized workflows on a mobile device, comprising:
a secure enclave configured to store verification material associated with one or more trusted external authorities;
a verification module configured to validate externally signed instruction payloads using the stored verification material;
a policy enforcement module configured to authorize execution of a device-local action based solely on internal validation results; and
wherein the apparatus performs verification and execution without maintaining backend session state or transmitting validation results to the issuing authority.

4. The apparatus of claim 1, wherein the vault-sealed public key store is initialized through a post-quantum asymmetric key exchange during a one-time pairing event.

5. The apparatus of claim 1, wherein the signed payload is delivered to the mobile device through an intermediary trust authority that does not retain decrypted payload content.

6. The apparatus of claim 1, wherein verification of the signed payload is performed without invoking any asymmetric cryptographic operation after initial trust establishment.

7. The apparatus of claim 1, wherein the signed payload includes a freshness indicator selected from a nonce or timestamp, and wherein validation is rejected if the freshness indicator fails an internal vault-based validation check.

8. The apparatus of claim 1, wherein the signed payload is obfuscated through one or more recursive encryption or padding layers prior to verification.

9. The apparatus of claim 1, wherein the apparatus maintains a directional key model comprising a Receive Key for inbound instruction encryption and a distinct Send Key for outbound communication.

10. The apparatus of claim 9, wherein the Receive Key and Send Key are stored in separate vault compartments and rotated independently.

11. The apparatus of claim 1, wherein the apparatus is configured to operate without storing signed instruction payloads outside the secure execution environment.

12. The method of claim 2, wherein validation is performed without generating any external acknowledgment sufficient to confirm successful verification.

13. The method of claim 2, wherein the verification key is associated with a regulated third-party authority selected from a financial institution, payment processor, or regulatory system.

14. The method of claim 2, wherein execution of the protected workflow is denied if vault integrity validation fails.

15. The apparatus of claim 1, wherein validation of the signed payload is determined exclusively using vault-resident state and policy logic without transmission of any externally observable validation outcome sufficient to confirm success.

16. The apparatus of claim 1, wherein execution of the protected workflow is permitted only if a hardware-backed integrity check of the secure execution environment is satisfied.
